(19) United States
(12) Patent Application Publication
(10) Pub. No.: US 2010/0110126 A1
(43) Pub. Date: May 6, 2010

(54) METHOD FOR DRIVING DROPLET EJECTING HEAD AND DROPLET EJECTING DEVICE

(75) Inventor: Akira SANO, Shiojiri (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/563,192

(22) Filed: Sep. 21, 2009

(30) Foreign Application Priority Data
Nov. 5, 2008 (JP) 2008-284526

(51) Int. Cl. B41J 29/38; B41J 2/045

(52) U.S. Cl. 347/10; 347/68

(57) ABSTRACT

A method for driving a droplet ejecting head that includes a liquid pressure chamber communicating with a nozzle hole, and a pressure application unit applying pressure on liquid stored in the liquid pressure chamber for ejecting a droplet from the nozzle hole, includes applying on the liquid stored in the liquid pressure chamber pressure having a waveform whose phase is delayed by 90 degrees from a waveform of a residual vibration of the liquid by the pressure application unit after an ejection of the droplet from the nozzle hole.

### CROSS-REFERENCE TO RELATED APPLICATION

1. Technical Field

This application is based on and claims priority from Japanese Patent Application No. 2008-284526, filed on Nov. 5, 2008, the contents of which are incorporated herein by reference.

### BACKGROUND

1. Technical Field

The present invention relates to a method for driving a droplet ejecting head, and a droplet ejecting device driving the droplet ejecting head by using the method.

2. Related Art

As a droplet ejecting head used to eject droplets, an inkjet head mounted to an apparatus such as an inkjet recording apparatus is known. The inkjet head ejects ink in a liquid pressure chamber from nozzle holes by vibrationally applying pressure to the ink. At this time, vibration remains in the ink in the liquid pressure chamber even after the ejection of the ink. Therefore, ejecting operations performed after the vibration is stopped and during the vibration have different ejecting characteristics (quantity and speed).

In particular, in an inkjet head using an electrostatic actuator, vibration remains in a vibration plate after an ejection of ink. When the vibration plate is vibrated, the distance between the vibration plate and a fixed electrode facing the vibration plate constantly changes. Therefore, even if the same voltage is applied between the vibration plate and the fixed electrode, the magnitude of electrostatic force generated varies widely according to the timing, so that the movement of the vibration plate is not constant. It directly affects the ejecting characteristics.

On the other hand, in an inkjet printer forming an image by selecting an on/off of ejection on demand, a time interval between ejection constantly changes. Then, a minimum time interval serves as an element in determining the printing speed. In order to stably uniformize the ejecting characteristics for realizing a high-quality image printing with such inkjet printer, suppressing a residual vibration after the ejection within the minimum time interval can be an effective method. With such inkjet printer that has to wait for a residual vibration to be naturally attenuated by a flow path, the printing speed cannot be increased.

In order to increase the printing speed, various methods for actively controlling vibration have been proposed. JP-A-2003-136712 is an example of related art in which an example of the method is disclosed. The example of the method includes two steps. In a first step, for contacting a vibration plate 22 with an individual electrode 11, an electrostatic force is generated by applying a driving voltage pulse to an electrostatic actuator including the vibration plate 22 and the individual electrode 11 that are disposed so as to face each other with a predetermined interval therebetween. In a second step, the vibration plate 22 is vibrated by releasing the contact with the individual electrode 11 to generate a liquid pressure variation. The liquid pressure variation is utilized for ejecting droplets from nozzles 31. In the second step of the method, a vibration having an opposite phase to that of a residual vibration of liquid is applied to the vibration plate 22 after the ejection of the droplets.

In the related art droplet ejecting head (the inkjet head), a vibration having an opposite phase to that of a residual vibration of liquid is applied to the liquid (a vibration plate) for achieving early suppression of the residual vibration of the liquid (the vibration plate) (e.g., refer to the example of related art). However, there is a problem that an input waveform suitable for suppressing a residual vibration is not always a vibration having an opposite phase to that of the residual vibration of the liquid.

### SUMMARY

An advantage of the invention is to provide a method for driving a droplet ejecting head that is more suitable for suppressing a residual vibration than a related art method, and a droplet ejecting device for driving the droplet ejecting head using the method.

According to a method for driving a droplet ejecting head of a first aspect of the invention, the droplet ejecting head includes a liquid pressure chamber communicating with a nozzle hole, and a pressure application unit applying pressure on liquid stored in the liquid pressure chamber for ejecting a droplet from the nozzle hole. The method includes applying on the liquid stored in the liquid pressure chamber pressure having a waveform whose phase is delayed by 90 degrees from a waveform of a residual vibration of the liquid by the pressure application unit after an ejection of the droplet from the nozzle hole. Therefore, the residual vibration after the ejection of the droplet can be quickly suppressed, and the return movement after the ejection of the droplet can be promptly performed. Accordingly, a driving frequency of the droplet ejecting head can be enhanced.

According to a method for driving a droplet ejecting head of a second aspect of the invention, the droplet ejecting head includes a liquid pressure chamber communicating with a nozzle hole, a vibration plate formed in the liquid pressure chamber, and a fixed electrode disposed so as to face the vibration plate with a predetermined interval between the fixed electrode and the vibration plate, and applies pressure to liquid stored in the liquid pressure chamber by deforming the vibration plate by an electrostatic force generated by a driving voltage applied between the vibration plate and the fixed electrode for ejecting a droplet from the nozzle hole. The method includes applying between the vibration plate and the fixed electrode a vibration control voltage having one of a rectangular waveform and a trapezoidal waveform for controlling a residual vibration of the liquid after an ejection of the droplet from the nozzle hole. In the method, the residual vibration vibrates between an upper position and a bottom position through an equilibrium position. A charge of the vibration control voltage is completed between the bottom position and the equilibrium position while a discharge of the vibration control voltage starts between the upper position and the equilibrium position where the upper position is where a liquid surface of the residual vibration is the farthest toward the vibration plate from the nozzle hole, the bottom position is where the liquid surface of the residual vibration is the farthest in a liquid ejecting direction from the nozzle hole, and the equilibrium position is a center between the upper position and the bottom position. When pressure is applied to the liquid by the vibration plate, (i.e., the electrostatic actuator including the vibration plate and the individual electrode), it may be difficult to apply to the liquid pressure having a waveform whose phase is delayed by 90 degrees from that of the residual vibration. However, by applying the vibration control voltage as described above, pressure having a waveform approximating the waveform whose phase is delayed by 90 degrees from that of the residual vibration can be applied to the liquid. Therefore, the residual vibration after the ejection of the droplet can be quickly suppressed, and the return movement after the ejection of the droplet can be promptly performed. Accordingly, a driving frequency of the droplet ejecting head can be enhanced.

According to the method for driving a droplet ejecting head, a voltage value of the vibration control voltage may be smaller than a voltage value of the driving voltage. Therefore, when the vibration control voltage is applied, droplets can be prevented from being ejected from the nozzle hole.

According to a method for driving a droplet ejecting head of a third aspect of the invention, the droplet ejecting head includes a liquid pressure chamber communicating with a nozzle hole, a vibration plate formed in the liquid pressure chamber, and a fixed electrode disposed so as to face the vibration plate with a predetermined interval between the fixed electrode and the vibration plate, and applies pressure to liquid stored in the liquid pressure chamber by deforming the vibration plate by an electrostatic force generated by a driving voltage applied between the vibration plate and the fixed electrode for ejecting a droplet from the nozzle hole. The method includes applying between the vibration plate and the fixed electrode a vibration control voltage having a stepped waveform for controlling a residual vibration of the liquid after an ejection of the droplet from the nozzle hole. In the method, the residual vibration vibrates between an upper position and a bottom position through an equilibrium position. A charge of the vibration control voltage is completed between the bottom position and the equilibrium position while a discharge of the vibration control voltage starts between the upper position and the equilibrium position where the upper position is where a liquid surface of the residual vibration is the farthest toward the vibration plate from the nozzle hole, the bottom position is where the liquid surface of the residual vibration is the farthest in a liquid ejecting direction from the nozzle hole, and the equilibrium position is a center between the upper position and the bottom position. Accordingly, pressure having a waveform approximating the waveform whose phase is delayed by 90 degrees from that of the residual vibration can be applied.

According to the method for driving a droplet ejecting head, a voltage value per step of the vibration control voltage may be smaller than a voltage value of the driving voltage. Therefore, when the vibration control voltage is applied, droplets can be prevented from being ejected from the nozzle hole.

According to the method for driving a droplet ejecting head, the fixed electrode may have a stepped structure. Therefore, pressure corresponding to the stepped structure can be applied to the liquid.

According to a fourth aspect of the invention, a droplet ejecting device includes a droplet ejecting head to which the method for driving a droplet ejecting head of the first aspect is applied. Therefore, the droplet ejecting device can be obtained that quickly suppresses a residual vibration of ink after an ejection of droplets and operates at high speed.

### BRIEF DESCRIPTION OF THE DRAWINGS

The invention will be described with reference to the accompanying drawings, wherein like numbers reference like elements.

FIG. 1 is an exploded perspective view of an inkjet head according to a first embodiment.

FIG. 2 is a sectional side view when the inkjet head shown in FIG. 1 is bonded together.

FIG. 3 is a block diagram schematically showing a structural example of a control system of the inkjet head.

FIGS. 4A and 4B are characteristic diagrams showing a method for controlling residual vibration according to the first embodiment.

FIG. 5 is a characteristic diagram showing an example of an applied voltage waveform of an electrostatic actuator according to a second embodiment.

FIGS. 6A, 6B, and 6C are characteristic diagrams showing a method for controlling residual vibration when a residual vibration voltage shown in FIG. 5 is applied.

FIGS. 7A, 7B, and 7C are characteristic diagrams showing a method for controlling residual vibration according to the second embodiment.

FIG. 8 shows a structure of an inkjet printer according to a third embodiment.

### DESCRIPTION OF EXEMPLARY EMBODIMENTS

### First Embodiment

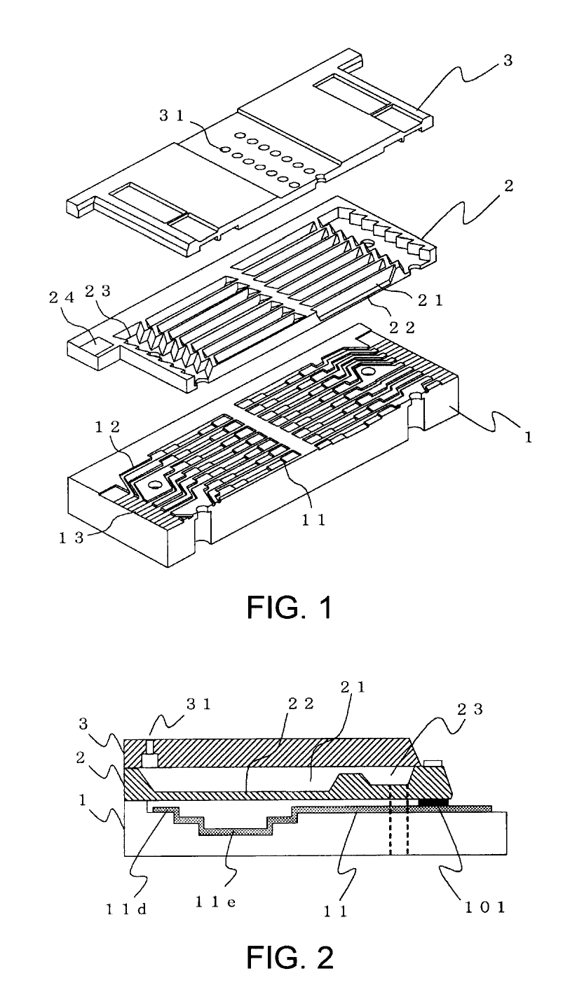

FIG. 1 is an exploded perspective view schematically showing an inkjet head (an example of a droplet ejecting head) according to a first embodiment of the invention. The inkjet head shown in FIG. 1 has a triple-layer structure including three substrates, an electrode glass substrate 1, a cavity substrate 2, and a nozzle wafer 3, bonded together. The cavity substrate 2 is bonded on the electrode glass substrate 1, and the nozzle wafer 3 is bonded on the cavity substrate 2. Hereinafter, structures of each substrate will be described.

The electrode glass substrate 1 is made of a glass substrate with a thickness of about 1 mm, for example. In particular, it is suitable to use a hard heat-resistant glass, such as a borosilicate glass, having a thermal expansion coefficient close to that of a silicon substrate as the cavity substrate 2. This is because, when the electrode glass substrate 1 and the cavity substrate 2 are anodically bonded together, the close thermal expansion coefficients between both substrates can reduce stress occurring between the electrode glass substrate 1 and the cavity substrate 2, with the result that the electrode glass substrate 1 and the cavity substrate 2 can be strongly bonded together without problems such as stripping. A plurality of concave parts is formed on a surface of the electrode glass substrate 1 by etching, and each concave part includes an individual electrode 11 that is formed therein and is made of indium tin oxide (ITO). The individual electrode 11 corresponds to a fixed electrode according to the invention. The individual electrode 11 has a stepped structure having a plurality of steps formed in a thickness direction of the electrode glass substrate 1, and is disposed so as to face a vibration plate 22 of the cavity substrate 2. The individual electrode 11 is coupled to an individual electrode terminal section 13 through an individual electrode wiring section 12.

The cavity substrate 2 is made of a silicon substrate with a thickness of about 30 μm, for example. The cavity substrate 2 includes an insulation film made of tetraethylorthosilicate (TEOS) or tetraethoxysilane (ethyl silicate) with a thickness of 0.1 μm on the lower surface to which the electrode glass substrate 1 is bonded. The insulation film is formed by plasma chemical vapor deposition (CVD) or the like. The insulation film is formed to prevent insulation breakdown and short circuit when the inkjet head is driven. Besides TEOS, the insulation film may be made of SiON, Al₂O₃, Ta₂O₅, HfO₂, or the like.

The cavity substrate 2 includes ink pressure chambers 21, the vibration plates 22, common ink chambers 23, and a common electrode 24. The ink pressure chamber 21 corresponds to a liquid pressure chamber according to the invention. The ink pressure chamber 21 stores ink to be ejected from nozzle holes 31, and is provided corresponding to each nozzle hole 31. The vibration plate 22 is disposed on the bottom of each ink pressure chamber 21 so as to face the individual electrode 11. The vibration plate 22 and the individual electrode 11 are included to an electrostatic actuator. The electrostatic actuator (the vibration plate 22 and the individual electrode 11) corresponds to a pressure application unit according to the invention. Operations of the electrostatic actuator will be described in detail below referring to FIG. 2. The common ink chambers 23 are supplied with ink through an ink supply path provided outside (not shown in figures). Coupled to the common electrode 24 is a common output terminal COM of a driver IC 309 described below.

The nozzle wafer 3 is made of a silicon substrate with a thickness of about 50 μm, for example. Disposed at a predetermined pitch on the nozzle wafer 3 are the nozzle holes 31 that are ink ejection orifices.

FIG. 2 is a sectional side view when the inkjet head having a triple-layer structure shown in FIG. 1 is bonded together. Hereinafter, operations of the inkjet head will be described with reference to FIG. 2. On the bottom of each of ink pressure chamber 21, the vibration plate 22 is formed that vibrates vertically with respect to a surface of the vibration plate 22. The vibration plate 22 and the individual electrode 11 disposed facing each other are included to the electrostatic actuator. An open end section of the gap formed between the vibration plate 22 and the individual electrode 11 is airtightly sealed with a sealant 101 made of epoxy resin or the like to prevent entry of moisture, dust, or the like into the gap.

The vibration plate 22 is vibrated by utilizing an electrostatic force generated by applying a driving voltage pulse to the electrostatic actuator. The vibration of the vibration plate 22 increases the volume of the ink pressure chamber 21. Accordingly, ink droplets are ejected from the nozzle 31 communicating with the ink pressure chamber 21 based on an ink pressure variation generated in the ink pressure chamber 21.

In FIG. 2, the individual electrode 11 has a stepped structure. A highest section 11d is the first step while a lowest section 11e is the third step. According to a voltage value of the driving voltage pulse applied to the individual electrode 11, the vibration plate 22 contacts with the individual electrode 11 at different steps. For example, in order to contact the vibration plate 22 with the individual electrode 11 at the lowest section 11e, it is required to generate increased coulomb force. Therefore, a voltage value of the driving voltage pulse applied to the individual electrode 11 is increased. On the other hand, in a case where the vibration plate 22 contacts with the individual electrode 11 at the highest section 11d, a smaller voltage value is adequate.

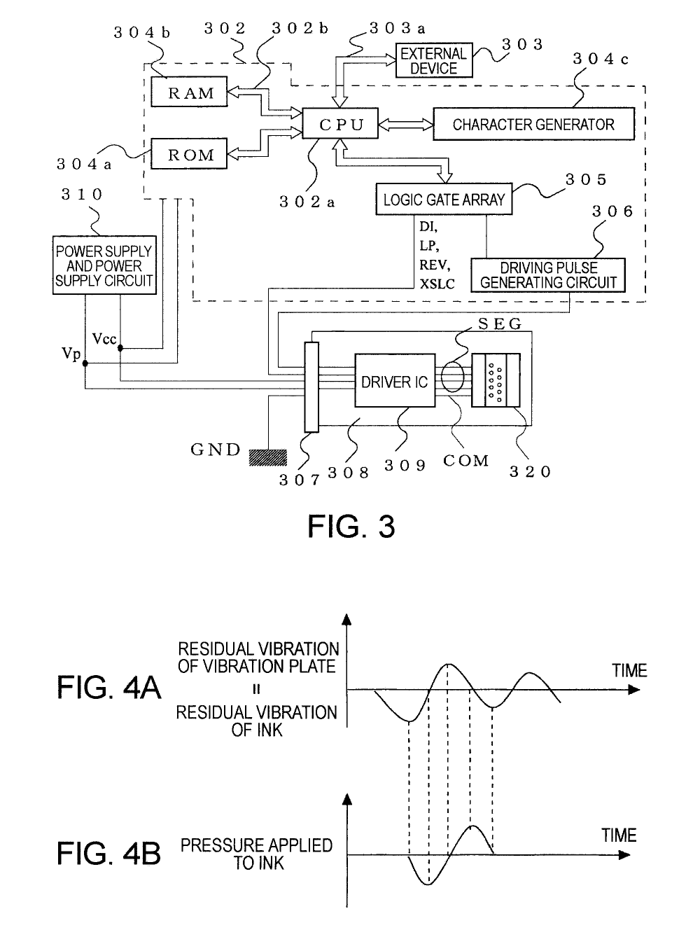

FIG. 3 is a block diagram schematically showing a structural example of a control system of the inkjet head. Hereinafter, control operations of the inkjet head according to the first embodiment will be described with reference to FIG. 3. The control system of the inkjet head shown in FIG. 3 includes an inkjet head controller 302 provided with a CPU 302a as a major part. The CPU 302a is supplied with printing information through a bus 303a from an external device 303. Further, the CPU 302a is coupled to a ROM 304a, RAM 304b, and a character generator 304c through an internal bus 302b.

The inkjet controller 302 executes a control program stored in the ROM 304a by using a storage area in the RAM 304b as a working area to generate a control signal for driving the inkjet head based on character information generated from the character generator 304c. The control signal passes through a logic gate array 305 and a driving pulse generating circuit 306 so as to be converted into a driving control signal corresponding to the printing information. Then, the driving control signal is supplied to the driver IC 309 formed on a head substrate 308 through a connector 307. The driver IC 309 also receives a driving voltage pulse V3 for printing, a driving signal DI, a control signal LP, a polarity inversion control signal REV, reference transmission clocks XSCL and GND, and the like.

The driver IC 309 outputs a driving voltage pulse, which is applied to the common electrode 24 and the individual electrode 11 shown in FIG. 1, respectively from a common output terminal COM and individual electrode terminals SEG based on the above supplied signals. Further, the driver IC 309 outputs a driving voltage pulse, which is applied to the individual electrode 11 corresponding to each nozzle hole 31, from the individual electrode terminals SEG provided the number corresponding to that of the individual electrode 11. The potential difference between outputs of the common output terminal COM and the individual output terminals SEG is applied between the vibration plate 22 corresponding to each nozzle hole 31 and the individual electrode 11 facing the vibration plate 22. A driving potential difference waveform having a designated direction is given when the vibration plate 22 is driven (ejecting ink) while no driving potential difference is given when the vibration plate 22 is not driven.

Residual Vibration Control

After an ink droplet is ejected from the nozzle hole 31, residual vibration remains in the vibration plate 22 (ink in the ink pressure chamber 21). In the first embodiment, a control for suppressing the residual vibration is performed after ink droplet ejection.

FIGS. 4A and 4B are characteristic diagrams showing a method for controlling residual vibration according to the first embodiment of the invention. FIG. 4A shows a residual vibration of the vibration plate 22 after ink droplet ejection. In other words, FIG. 4A shows a residual vibration of the ink in the ink pressure chamber 21 after ink droplet ejection. FIG. 4A shows that the vibration plate 22 is separated from the individual electrode 11 as it toward the upper side of the figure. In other words, in FIG. 4A, the ink is positioned at the farthest position in a liquid ejecting direction from the nozzle hole 31 as it toward the upper side of the figure. Further, FIG. 4B shows pressure applied to the ink for suppressing the residual vibration. The pressure is applied by applying a vibration control voltage between the vibration plate 22 and the individual electrode 11.

As is apparent from FIGS. 4A and 4B, pressure having a waveform whose phase is delayed by 90 degrees from that of the residual vibration of the ink (the vibration plate 22) is applied to the ink (the vibration plate 22) to suppress the residual vibration. As applying the pressure to the ink, an electrostatic force that does not change the vibration direction of the vibration plate 22 or an electrostatic force that allows the vibration plate 22 to be contacted with the individual electrode 11 may be generated. In a case where the vibration plate 22 is contacted with the individual electrode 11, the pressure applied to the ink may be adjusted according to the step of the individual electrode 11 with which the vibration plate 22 contacts.

Hereinafter, reasons for applying pressure to the ink (the vibration plate 22) for suppressing residual vibration as shown in FIG. 4 will be described.

Ignoring the existence of the ink in the ink pressure chamber 21 and paying attention to only the motion of the vibration plate 22, an equation of motion (a differential equation) of the vibration plate 22 during the vibration is as follows.

M*x″+R*x′+C*x=P Formula (1)

Here, x denotes volume displacement in the ink pressure chamber 21. x′ is obtained by differentiating x once with respect to time, and denotes volume displacement velocity in the ink pressure chamber 21. x″ is obtained by differentiating x twice with respect to time, and denotes volume displacement acceleration in the ink pressure chamber 21. Further, M denotes inertance, R denotes flow path resistance, C denotes compliance, and P denotes an electrostatic pressure applied as an external force (pressure applied to the ink). The volume of the ink pressure chamber 21 is displaced in accordance with the deformation of the vibration plate 22. Thus, this x can be considered as a displacement amount of the vibration plate 22.

Here, considering a general feedback control for the vibration control, the method for applying the external force P for suppressing the vibration is known as the following formula by using the volume displacement x and the volume displacement velocity x′.

P=−(αx+βx′) Formula (2) (α>0, β>0)

There are various methods (mathematical solutions) for determining α and β. For example, in a case where values of α and β are determined by empirical values of experiment and the like, it is preferable to weight a value of β (set a value of β larger) because stopping the movement (velocity) of the vibration plate 22 in a short time leads to attenuating the residual vibration early.

For example, the volume displacement velocity x′ is expressed as x′=Aω cos ωt where α=β=1 and the volume displacement x is expressed as x=A sin ωt. In an inkjet head, the value of ω, a natural angular frequency, is sufficiently greater than 1. Thus, the value of amplitude of the volume displacement velocity x′ is sufficiently greater than that of the volume displacement x.

Therefore, in regard to the external force P, the term of the volume displacement velocity x′ becomes the dominant term, and thereby Formula (1) can be considered as follows.

P≈−βx′ Formula (3)

From Formula (3), it is found that the external force P is a waveform having an opposite phase to that of the volume displacement velocity x′. That is, since the volume displacement velocity x′ is a waveform having a phase lead of 90 degrees with respect to that of the volume displacement x, the external force P is a waveform having a phase delayed by 90 degrees with respect to that of the volume displacement x.

Therefore, pressure having a waveform whose phase is delayed by 90 degrees from that of the residual vibration of the ink (the vibration plate 22) is applied to the ink (the vibration plate 22), so that the residual vibration can be quickly suppressed. In other words, the return movement of the inkjet head after ink ejection can be promptly performed. Accordingly, a driving frequency of the inkjet head can be enhanced.

In the first embodiment, the electrostatic actuator (the vibration plate 22 and the individual electrode 11) is employed as a pressure application unit. However, various devices can also be employed. For example, a piezo-piezoelectric element may be used as a pressure application unit.

### Second Embodiment

When pressure is applied to the ink by the electrostatic actuator (the vibration plate 22 and the individual electrode 11), it may be difficult to apply pressure having a waveform whose phase is delayed by 90 degrees from that of the residual vibration. However, pressure having a waveform approximating the waveform whose phase is delayed by 90 degrees from that of the residual vibration of the ink is applied to the ink, so that the residual vibration can be quickly suppressed. Note that in the second embodiment, the same numerals are given to the same functions and structures as those in the second embodiment.

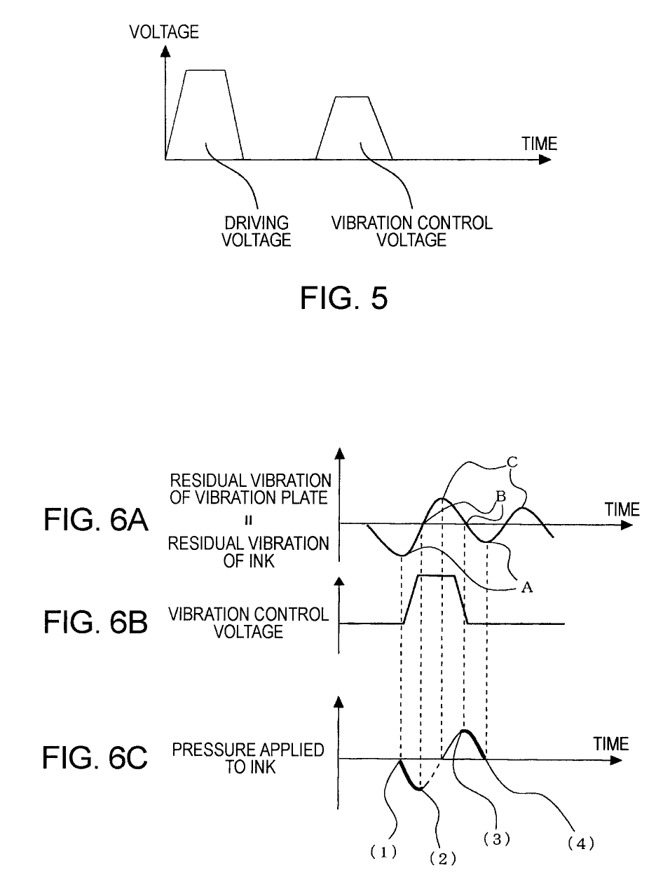

FIG. 5 is a characteristic diagram showing an example of an applied voltage waveform of the electrostatic actuator according to the second embodiment of the invention. In the second embodiment, after a driving voltage for ejecting ink droplets is applied to the electrostatic actuator (the vibration plate 22 and the individual electrode 11), a vibration control voltage for suppressing residual vibration is applied thereto. A voltage value of the vibration control voltage is smaller than that of the driving voltage. Although the vibration control voltage has a nearly trapezoidal waveform, it may be a nearly rectangular waveform according to charge time and discharge time.

Residual Vibration Control

In the second embodiment, residual vibration is suppressed as below by applying a vibration control voltage waveform in a nearly trapezoidal waveform (or nearly rectangular waveform) to the electrostatic actuator (the vibration plate 22 and the individual electrode 11). FIGS. 6A, 6B, and 6C are characteristic diagrams showing a method for controlling residual vibration when the residual vibration voltage shown in FIG. 5 is applied to the electrostatic actuator. FIG. 6A shows a residual vibration of the vibration plate 22 after ink droplet ejection. In other words, FIG. 6A shows a residual vibration of the ink in the ink pressure chamber 21 after ink droplet ejection. FIG. 6A shows that the vibration plate 22 is separated from the individual electrode 11 as it toward the upper side of the figure. In other words, in FIG. 6A, the ink is positioned at the farthest position in a liquid ejecting direction from the nozzle hole 31 as it toward the upper side of the figure. FIG. 6B shows a waveform of the vibration control voltage. Further, FIG. 6C shows pressure applied to the ink for suppressing the residual vibration. The parts shown in a full line in the waveform in FIG. 6C indicate the actual application of the pressure to the ink.

In the description hereinafter, a position where the vibration plate 22 is the closest to the individual electrode 11, in other words, a position where a surface of the ink is the farthest toward the vibration plate 22 from the nozzle hole 31, is denoted as a bottom position A. A position where the vibration plate 22 is the farthest from the individual electrode 11, in other words, a position where the surface of the ink is the farthest in a liquid ejecting direction from the nozzle hole 31, is denoted as an upper position C. Further, the center of the bottom position A and the upper position C is denoted as an equilibrium position B.

As is apparent from FIG. 6B, a charge of the vibration control voltage is completed between the bottom position A and the equilibrium position B. Accordingly, between positions (1) to (2) shown in FIG. 6C, pressure having a waveform approximating the waveform whose phase is delayed by 90 degrees from that of the residual vibration can be applied to the ink. Meanwhile, a discharge of the vibration control voltage starts between the upper position C and the equilibrium position B. Accordingly, between positions (3) to (4) shown in FIG. 6C, pressure having a waveform approximating the waveform whose phase is delayed by 90 degrees from that of the residual vibration can be applied to the ink.

As described, residual vibration can also be quickly suppressed by applying a vibration control pressure to the electrostatic actuator (the vibration plate 22 and the individual electrode 11). In other words, the return movement of the inkjet head after ink ejection can be promptly performed. Accordingly, a driving frequency of the inkjet head can be enhanced.

Further, a voltage value of the vibration control voltage is smaller than that of the driving voltage, so that ink droplets can be prevented from being ejected when the residual vibration is controlled. In this case, since the individual electrode 11 has a stepped structure as shown in FIG. 2, the pressure applied to the ink to can be easily adjusted according to the step of the individual electrode 11 with which the vibration plate 22 contacts.

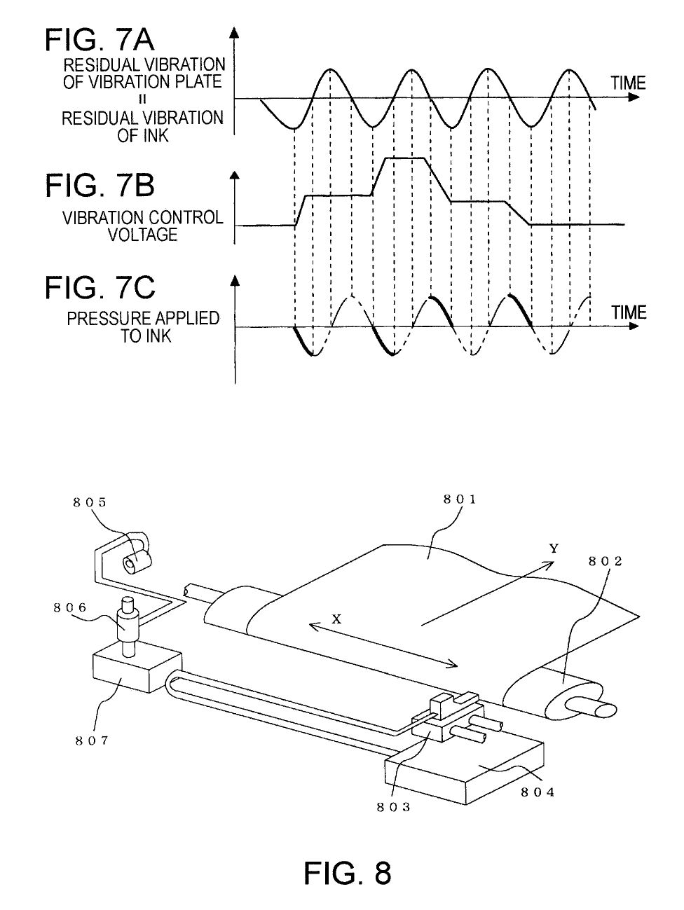

The waveform of the vibration control voltage is not limited to the nearly trapezoidal waveform (or nearly rectangular waveform). For example, as shown in FIG. 7, the waveform of the vibration control voltage may be a stepped waveform.

FIGS. 7A, 7B, and 7C are characteristic diagrams showing another method for controlling residual vibration according to the second embodiment of the invention. FIG. 7A shows a residual vibration of the vibration plate 22 after ink droplet ejection. In other words, FIG. 7A shows a residual vibration of the ink in the ink pressure chamber 21 after ink droplet ejection. FIG. 7A shows that the vibration plate 22 is separated from the individual electrode 11 as it toward the upper side of the figure. In other words, in FIG. 7A, the ink is positioned at the farthest position in a liquid ejecting direction from the nozzle hole 31 as it toward the upper side of the figure. FIG. 7B shows an example of a waveform of a vibration control voltage. In FIG. 7B, the vibration control voltage is applied in a stepped waveform. At this time, the voltage value of one step (the voltage difference of each step) is smaller than that of the driving voltage. Further, FIG. 7C shows pressure applied to the ink for suppressing the residual vibration. The parts shown in a full line in the waveform in FIG. 7C indicate the actual application of the pressure to the ink.

As is apparent from FIG. 7B, a charge of the vibration control voltage is completed between the bottom position A and the equilibrium position B. Accordingly, pressure having a waveform approximating the waveform whose phase is delayed by 90 degrees from that of the residual vibration can be applied to the ink. Meanwhile, a discharge of the vibration control voltage starts between the upper position C and the equilibrium position B. Accordingly, pressure having a waveform approximating the waveform whose phase is delayed by 90 degrees from that of the residual vibration can be applied to the ink.

As described, a residual vibration can also be quickly suppressed by applying a vibration control pressure to the electrostatic actuator (the vibration plate 22 and the individual electrode 11). Further, a vibration control voltage is applied in a stepped waveform, so that pressure having a waveform approximating the waveform whose phase is delayed by 90 degrees from that of the residual vibration can be applied to the ink. Therefore, the return movement of the inkjet head after ink ejection can be promptly performed. Accordingly, a driving frequency of the inkjet head can be enhanced.

Additionally, a voltage value of one step of the vibration control voltage (the voltage difference between each step) is smaller than that of the driving voltage, ink droplets can be prevented from being ejected when the residual vibration is controlled. In this case, since the individual electrode 11 has a stepped structure as shown in FIG. 2, the pressure applied to the ink can be easily adjusted according to the step of the individual electrode 11 with which the vibration plate 22 contacts.

The shape of the stepped waveform of the vibration control voltage is not limited to the one shown in FIG. 7B. For example, the stepped waveform shown in FIG. 7B may not have steps on either one side thereof. Alternatively, for example, the stepped waveform may have three steps or more.

### Third Embodiment

FIG. 8 shows a structure of an inkjet printer (an example of a droplet ejecting device) according to a third embodiment of the invention. The inkjet printer shown in FIG. 8 includes a platen 802 for feeding a recording sheet 801 in a sub-scanning direction Y, an inkjet head (not shown) whose ink nozzle faces confront the platen 802, a carriage 803 for reciprocating the inkjet head in a main-scanning direction X, and an ink tank 804 for supplying ink to each ink nozzle of the inkjet head. A nozzle cap 805 is disposed at a position deviated from the platen 802 in the main-scanning direction X, and the nozzle cap 805 is communicated with a waste ink recovery section 807 through an ink pump 806. As a structure of the inkjet head and a method for driving the same, those described in the first and the second embodiments can be employed.

In the third embodiment, an example is described in which the droplet ejecting head and the method for driving the same described in the first and the second embodiments are applied to the inkjet printer that is an example of a droplet ejecting device. However, the example is not limited to this. For example, the driving method described in the first and the second embodiments can also be used in devices such as an optical switch, a mirror device, and a driving section of a laser operation mirror of a laser printer.

As described above, according to the inkjet printer according to the third embodiment, an inkjet printer can be obtained that is capable of quickly suppressing a residual vibration of the ink in the ink pressure chamber 21 and operating at high speed.

What is claimed is:

1. A method for driving a droplet ejecting head that includes a liquid pressure chamber communicating with a nozzle hole, and a pressure application unit applying pressure on liquid stored in the liquid pressure chamber for ejecting a droplet from the nozzle hole, the method comprising:
applying on the liquid stored in the liquid pressure chamber pressure having a waveform whose phase is delayed by 90 degrees from a waveform of a residual vibration of the liquid by the pressure application unit after an ejection of the droplet from the nozzle hole.

2. A driving device of a droplet ejecting head that includes a liquid pressure chamber communicating with a nozzle hole, and a pressure application unit applying pressure on liquid stored in the liquid pressure chamber for ejecting a droplet from the nozzle hole, comprising:
a driving circuit; and
a power supply coupled to the driving circuit, wherein after an ejection of the droplet from the nozzle hole, the driving circuit drives the pressure application unit so as to apply pressure having a waveform whose phase is delayed by 90 degrees from a waveform of a residual vibration of the liquid on the liquid stored in the liquid pressure chamber.

3. A method for driving a droplet ejecting head that includes a liquid pressure chamber communicating with a nozzle hole, a vibration plate formed in the liquid pressure chamber, and a fixed electrode disposed so as to face the vibration plate with a predetermined interval between the fixed electrode and the vibration plate, and applies pressure to liquid stored in the liquid pressure chamber by deforming the vibration plate by an electrostatic force generated by a driving voltage applied between the vibration plate and the fixed electrode for ejecting a droplet from the nozzle hole, the method comprising:
applying between the vibration plate and the fixed electrode a vibration control voltage having one of a rectangular waveform and a trapezoidal waveform for controlling a residual vibration of the liquid after an ejection of the droplet from the nozzle hole,
wherein the residual vibration vibrates between an upper position and a bottom position through an equilibrium position,
wherein a charge of the vibration control voltage is completed between the bottom position and the equilibrium position while a discharge of the vibration control voltage starts between the upper position and the equilibrium position, and
wherein the upper position is where a liquid surface of the residual vibration is the farthest toward the vibration plate from the nozzle hole, the bottom position is where the liquid surface of the residual vibration is the farthest in a liquid ejecting direction from the nozzle hole, and the equilibrium position is a center between the upper position and the bottom position.

4. The method for driving a droplet ejecting head according to claim 3, wherein a voltage value of the vibration control voltage is smaller than a voltage value of the driving voltage.

5. A method for driving a droplet ejecting head that includes a liquid pressure chamber communicating with a nozzle hole, a vibration plate formed in the liquid pressure chamber, and a fixed electrode disposed so as to face the vibration plate with a predetermined interval between the fixed electrode and the vibration plate, and applies pressure to liquid stored in the liquid pressure chamber by deforming the vibration plate by an electrostatic force generated by a driving voltage applied between the vibration plate and the fixed electrode for ejecting a droplet from the nozzle hole, the method comprising:
applying between the vibration plate and the fixed electrode a vibration control voltage having a stepped waveform for controlling a residual vibration of the liquid after an ejection of the droplet from the nozzle hole,
wherein the residual vibration vibrates between an upper position and a bottom position through an equilibrium position,
wherein a charge of the vibration control voltage is completed between the bottom position and the equilibrium position while a discharge of the vibration control voltage starts between the upper position and the equilibrium position, and
wherein the upper position is where a liquid surface of the residual vibration is the farthest toward the vibration plate from the nozzle hole, the bottom position is where the liquid surface of the residual vibration is the farthest in a liquid ejecting direction from the nozzle hole, and the equilibrium position is a center between the upper position and the bottom position.

6. The method for driving a droplet ejecting head according to claim 5, wherein a voltage value per step of the vibration control voltage is smaller than a voltage value of the driving voltage.

7. The method for driving a droplet ejecting head according to claim 3, wherein the fixed electrode has a stepped structure.

8. A droplet ejecting device, comprising:
a droplet ejecting head to which the method for driving a droplet ejecting head of claim 1 is applied.
